(19) United States
(12) Patent Application Publication
(10) Pub. No.: US 2015/0020090 A1
(43) Pub. Date: Jan. 15, 2015

(54) VIDEO DISPLAY APPARATUS AND TELEVISION SYSTEM

(71) Applicant: KABUSHIKI KAISHA TOSHIBA, Tokyo (JP)

(72) Inventor: Masataka MOTEKI, Tokyo (JP)

(73) Assignee: KABUSHIKI KAISHA TOSHIBA, Tokyo (JP)

(21) Appl. No.: 14/045,724

(22) Filed: Oct. 3, 2013

(30) Foreign Application Priority Data
Jul. 9, 2013 (JP) 2013-143998

(51) Int. Cl. H04N 21/454; H04N 21/236; H04N 21/482; H04N 21/434; H04N 21/4627; H04N 21/466; H04N 21/2747; H04N 21/41

(52) U.S. Cl. CPC H04N 21/454; H04N 21/2747; H04N 21/23614; H04N 21/4135; H04N 21/4348; H04N 21/4627; H04N 21/4661; H04N 21/482
USPC 725/28

(57) ABSTRACT

A video display apparatus which receives digital broadcasts transmitting program information for each program, includes a first setting unit configured to set first criteria for permitting viewing of the program, a second setting unit configured to set second criteria for blocking viewing of the program, and a control unit configured to compare the first criteria set by the first setting unit with the program information, compare the second criteria set by the second setting unit with the program information if the program has program information which matches the first criteria, and permit viewing of the program if the program has program information which does not match the second criteria.

### CROSS-REFERENCE TO RELATED APPLICATION

This application is based upon and claims the benefit of priority from Japanese Patent Application No. 2013-143998, filed Jul. 9, 2013, the entire contents of which are incorporated herein by reference.

### FIELD

Exemplary embodiments described herein relate generally to a video display apparatus and a television system for viewing audio-visual aids in a classroom situation.

### BACKGROUND

Showing “programs which can be used as educational materials” among broadcasted TV programs on the air or recording such programs once and reproducing the programs later is common in educational material systems used in school classes. It is relatively easy to construct and implement such a system by installing TV receivers in respective classrooms and connecting the TV receivers in the entire school to a network. Specifically, an audio-visual educational system capable of storing recorded programs on a server and reproducing the programs to be shown as needed in accordance with time schedules of the respective classrooms can be conveniently used.

Programs used for the audio-visual education system may be programs broadcasted by MHK-G and other private TV stations as well as “general educational programs broadcasted by MHK-E”, for example. That is, any programs may be used as long as “the programs can be used as educational materials in classes of their respective subjects.” Examples of such programs include programs relating to history, societies, current affairs, and the like, programs relating to the arts, programs relating to music, and programs dealing with local or hometown issues.

However, TV receivers of the same models as those of general retail products are commonly delivered to classrooms for the purpose of using the TV receivers as audio-visual aids. Therefore, it is a matter of course that not only programs for educational materials, but also any program can be viewed on the TV receivers installed in the classrooms.

One disadvantage of using such a system is that it is possible to view programs in the classrooms such as entertainment programs, which are not related to the class curriculum. For example, current TV receivers potentially have functions with which it is possible to relatively easily construct an audio visual aid system in a classroom situation. However, students can watch programs, which are not related to classes, without teachers' supervision if typical TV receivers are introduced into schools or classroom situations. Therefore, there is a possibility that teachers who are responsible for schools or classroom situations may hesitate to introduce such a system.

Thus, apparatuses in which viewing restrictions can be set on the TV receiver side and the operations for recording and reproducing programs can be restricted have been developed.

JP-A-2001-145033 discloses an apparatus including: a storage unit which stores a combination of a channel number, a time slot, and a category as condition information for programs, the viewing of which is to be restricted; and a unit which compares channel tuning information with the condition information stored in the storage unit and stopping reception of a selected program if the selected program matches content of the condition information stored on the storage unit, wherein the programs, viewing of which is restricted, can be selected and set on the receiving apparatus side separately from any viewing restrictions on a broadcasting station side, and wherein recording and reproducing programs are further stopped if programs to be recorded or reproduced match the condition information as a result of comparison with the condition information in the storage unit. That is, JP-A-2001-145033 discloses only a system which “restricts viewing of programs if conditions are met.”

### DESCRIPTION OF THE DRAWINGS

FIG. 1 is a system block diagram schematically showing a system of a video display apparatus according to an embodiment.

FIG. 2 is a configuration diagram schematically showing a television system according to an embodiment.

FIG. 3 is a diagram of an operation screen in a “specific terminal” shown in FIG. 2.

FIG. 4 is an example of a screen showing a state where an item “setting and referring to program selecting information” included in a menu screen is selected.

FIG. 5 is an example of a screen displayed after the item “setting and referring to program selecting information” is selected in FIG. 4.

FIG. 6 is an example of a screen displayed after an item “keyword” is selected in FIG. 5.

FIG. 7 is an example of a screen displayed after an item “keyword for permission” is selected in FIG. 6.

FIG. 8 is an example of a screen in which an item “keyword for blocking” is selected.

FIG. 9 is an example of a screen displayed after the item “keyword for blocking” is selected in FIG. 8.

FIG. 10 is an example of a screen in which the item “category information” is selected.

FIG. 11 is an example of a screen displayed after the item “category information” is selected in FIG. 10.

FIG. 12 is an example of a screen displayed after an item “permitted category information” is selected in FIG. 11.

FIG. 13 is an example of a screen in which an item “blocked category information” is selected.

FIG. 14 is an example of a screen displayed after the item “blocked category information” is selected in FIG. 13.

FIG. 15 is a diagram of an operation screen in the “specific terminal” shown in FIG. 2, which shows a state where an EPG screen is displayed in order to proceed to processing for setting permission or non-permission for viewing and recording individual programs.

FIG. 16 is a diagram showing a state where a sub-menu for performing setting processing for a program is displayed.

FIG. 17 is an example of a screen displayed after an item “setting and referring to viewing and recording permission” is selected in FIG. 16.

FIG. 18 is a diagram showing a state where the EPG screen is displayed.

FIG. 19 is a flowchart showing the conditions for filtering programs based on the setting for viewing and recording permission set by using FIGS. 4 to 18.

FIG. 20 is a flowchart showing the conditions that determine a program display state on the EPG screen based on a result of determining the conditions for filtering programs as described in FIG. 19.

FIG. 21 is a flowchart showing the conditions that a recorded content display state on a screen for a list of recorded programs based on the result of determining conditions for filtering programs as described in FIG. 19.

FIG. 22 is a flowchart showing the conditions for displaying an on-air program screen display state.

FIG. 23 is a diagram of the EPG screen in the general television receiver other than the “specific terminal” shown in FIG. 2.

FIG. 24 is a diagram of a screen showing a list of recorded programs in the general television receiver other than the “specific terminal” shown in FIG. 2.

FIG. 25 is a diagram of on-air program display by the general television receiver other than the “specific terminal” shown in FIG. 2.

### DETAILED DESCRIPTION

Embodiments of the invention provide a video display apparatus and a television system capable of setting a multistage restriction configuration such that all programs are blocked by default, programs which meet permission conditions are regarded to pass primary assessment, and programs which finally pass another assessment are permitted by applying blocking conditions to the programs which are regarded to pass the primary assessment.

According to an embodiment, there is provided a video display apparatus which receives digital broadcasts transmitting multiplexed program information corresponding to each program, the apparatus including: a first setting unit configured to set first information relating to a keyword or a category for permitting viewing of the program; a second setting unit configured to set second information relating to a keyword or a category for blocking viewing of the program; and a control unit configured to compare the first information set by the first setting unit with the program information of the program, compare the second information set by the second setting unit with the program information of a first program if the first program has program information which matches the first information, and permit viewing of a second program if the second program has program information which does not match the second information.

Hereinafter, a description will be given of embodiments with reference to the drawings.

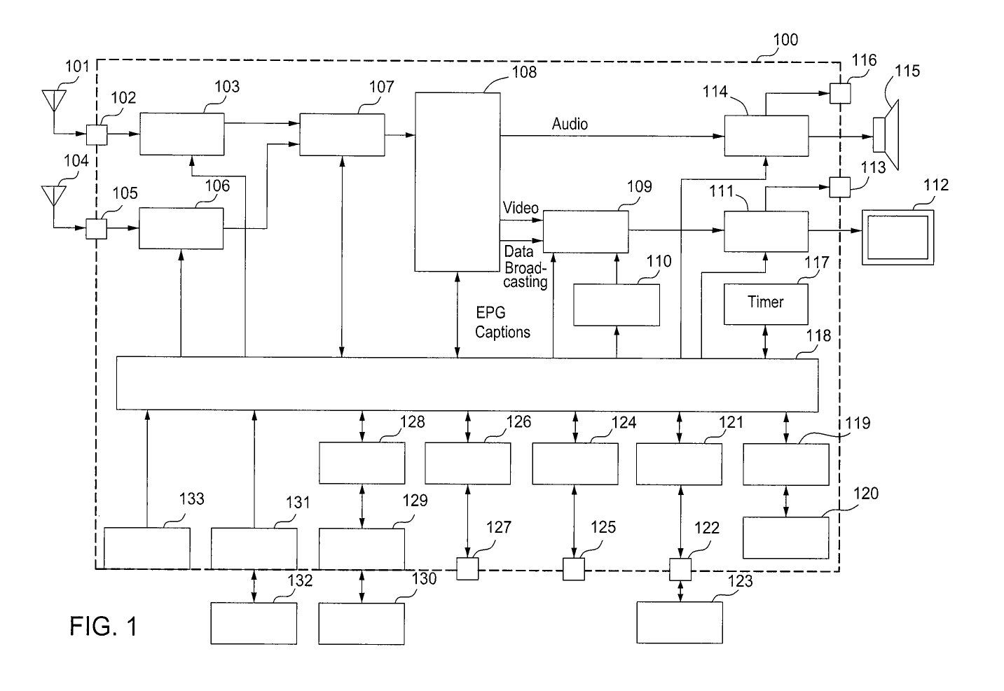

FIG. 1 is a system block diagram schematically showing a system of a video display apparatus according to an embodiment. In this embodiment, a video display apparatus 100 (television receiver) with a video recording function mounted thereon is described, and a hard disk and a semiconductor memory are mounted as recording media in the television receiver.

As shown in FIG. 1, a terrestrial digital television broadcasting signal received by an antenna 101 for receiving terrestrial broadcasts is supplied to a tuner unit 103 for terrestrial digital broadcasts via an input terminal 102.

On the other hand, a satellite digital television broadcasting signal received by an antenna 104 for receiving BS and CS broadcasts is supplied to a tuner unit 106 for BS and CS digital broadcasts via an input terminal 105. The terrestrial digital tuner unit 103 and the BS and CS digital tuner unit 106 respectively select broadcasting signals for desired channels by control signals from a control unit 118 and output the selected broadcasting signals to a decoder unit 107.

The decoder unit 107 demodulates the broadcasting signal selected by the terrestrial digital tuner unit 103 or the BS and CS digital tuner unit 106 based on the control signal from the control unit 118 and obtains a transport stream of MPEG2 including a desired program (MPEG2-TS). Furthermore, the decoder unit 107 performs a TS decoding processing on the transport-stream-multiplexed signal and outputs a Packetized Elementary Stream (PES) obtained by depacketing a digital video signal and a sound signal of the desired program to a signal processing unit 108. In addition, the decoder unit 107 also outputs section information obtained by the TS decoding processing to the signal processing unit 108.

The signal processing unit 108 performs predetermined digital signal processing on the digital video signal and the sound signal supplied from the decoder unit 107 and outputs the processed signals to a graphic processing unit 109 and a sound processing unit 114. In addition, if content recorded on a built-in or external hard disk (HDD) or the like is to be reproduced, the signal processing unit 108 selects a content reproduction signal input from the control unit 118, performs the predetermined digital signal processing thereon, and outputs the processed signal to the graphic processing unit 109 and the sound processing unit 114.

The signal processing unit 108 includes a section processing unit which is not shown in the drawing. The signal processing unit 108, through the section processing unit, outputs various data items for acquiring a program, Electronic Program Guide (EPG) information, program attribute information (e.g., a category of the program), caption information (e.g., service information, SI, and PSI) to the control unit 118 with the section information input from the decoder unit 107.

The control unit 118 performs image generation processing for displaying the Electronic Program Guide (EPG) and captions from the information input from the signal processing unit 108 and outputs the generated image information to the graphic processing unit 109.

The graphic processing unit 109 synthesizes (1) a digital video signal supplied from an Audio Visual (AV) decoder, which is not shown, in the signal processing unit 108, (2) an OSD signal generated by an On-Screen Display (OSD) signal generating unit 110, (3) image data from data broadcast, and (4) EPG and a caption signal generated by the control unit 118, and then outputs the synthesized signal to a video processing unit 111. In addition, the graphic processing unit 109 performs processing for superimposing caption information on the video signal based on the caption information controlled by the control unit 118 if captions for captioned broadcasting are to be displayed.

The video processing unit 111 converts the input digital video signal into a video signal in the format in which a video can be displayed on a display 112, and then causes the display 112 to display the video and externally derive the video via an output terminal 113.

In addition, the sound processing unit 114 converts the input digital sound signal into an analog sound signal in the format in which sound can be reproduced by speaker 115, then outputs the analog sound signal to the speaker 115, and causes the speaker 115 to reproduce the sound and externally derive the sound via an output terminal 116.

Control unit 118 controls all the operations of the television receiver 100 including the aforementioned receiving operation. The control unit 118 includes a built-in Central Processing Unit (CPU) and receives operation information from an operation unit 133. In addition, the control unit 118 receives the operation information transmitted from a remote controller 132 via a receiving unit 131 and controls each component such that the operation content is reflected. For example, the control unit 118 uses a Read Only Memory (ROM) which stores a control program to be executed mainly by the CPU, a Random Access Memory (RAM) which provides an operation area to the CPU, and a nonvolatile memory which stores various kinds of setting information and control information.

The control unit 118 is connected to a card holder 129, to which a memory card 130 can be attached via a card interface 128. As such, the control unit 118 can transmit information via the memory card 130 attached to the card holder 129 and the card interface 128.

In addition, for example, the control unit 118 is connected to a communication terminal 127 via a communication interface 126. Specifically, the communication interface 126 and the communication terminal 127 are mounted as a LAN interface and a LAN terminal, or a USB interface and a USB terminal. As such, the control unit 118 can transmit information via various devices connected to the communication terminal 127 and the communication interface 126.

Furthermore, the control unit 118 is connected to a communication terminal 125 via a communication interface 124 capable of integrally transmitting video and sound signals and a control signal, such as HDMI®. As such, the control unit 118 can transmit information in the form, in which the video and sound signals and the control signal are integrated, via various HDMI® devices connected to the communication terminal 125 and the communication interface 124.

In addition, the control unit 118 is connected to a built-in HDD 120 via a communication interface 119. As such, the control unit 118 can transmit information via the built-in HDD 120 and the communication interface 119. Specifically, it is possible to record a received broadcast program in the built-in HDD 120 and reproduce the broadcast program recorded in the built-in HDD 120 to allow a viewer to view the broadcast program.

Furthermore, the control unit 118 is connected to a communication terminal 122, to which an external HDD 123 can be attached, via a communication interface 121. As such, the control unit 118 can transmit information via the external HDD 123 attached to the communication terminal 122 and the communication interface 121. Specifically, it is possible to record a received broadcast program in the external HDD 123 and reproduce the broadcast program recorded in the external HDD 123 to allow a viewer to view the broadcast program.

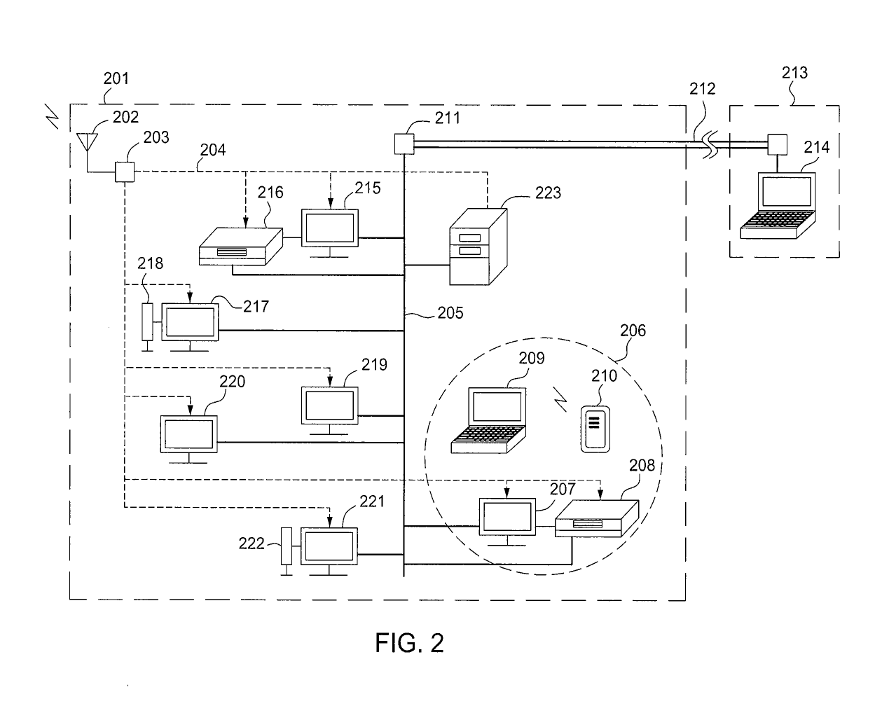

FIG. 2 is a configuration diagram schematically showing a television system according to an embodiment. As shown in FIG. 2, a television system 201, according to one embodiment, for an entire school includes a television receiver 207 as a “specific terminal”, a plurality of television receivers (215, 217, 219, 220, and 221) arranged in respective classrooms, video recorder apparatuses (208 and 216) connected to some television receivers, a program server apparatus 223, from which the plurality of television receivers can reproduce recorded and accumulated content so as to allow a viewer to view the content. In addition, such devices are connected to each other via a LAN connection 205 laid throughout the school. In addition, a broadcast wave received by an antenna 202 is appropriately split by a splitter 203 and then input to the individual television receivers, the video recorder apparatuses and the program server apparatus via a signal cable 204. In addition, the same is true in a case of a broadcast wave distributed from the outside of the school in the form of a cable television though not shown in the drawing. Moreover, a system block configuration of the television receiver 207 is assumed to be the same as that of the system block described with reference to FIG. 1.

The respective television receivers configuring the television system 201 can be freely connected to external devices. For example, the video recorder apparatuses 208 and 216 are connected to the television receivers 207 and 215, respectively, while external HDDs 218 and 222 are connected to other television receivers 217 and 221. In addition, no external device is connected to the television receivers 219 and 220.

In addition, content recorded in the external devices connected to these television receivers may be reproducible and viewable only by the television receivers to which the devices are connected, in accordance with setting content and connection states (e.g., DLNA connection) of the individual devices. Alternatively, the content may be reproducible and viewable by other television receivers which configure the television system 201.

The “specific terminal” 206 for setting the program filtering processing according to the exemplary embodiment is installed at a location where students cannot easily operate the terminal, such as a teachers' staff room. The setting content of the program filtering processing set by the “specific terminal” 206 is reflected in the other television receivers, video recorder apparatuses, and program server apparatus mutually connected via the LAN connection 205. For example, the setting for the filtering processing can be performed only by the “specific terminal” for those schools using broadcast programs as audio-visual aids for education, and students cannot easily change the settings through the television receivers installed in the respective classrooms.

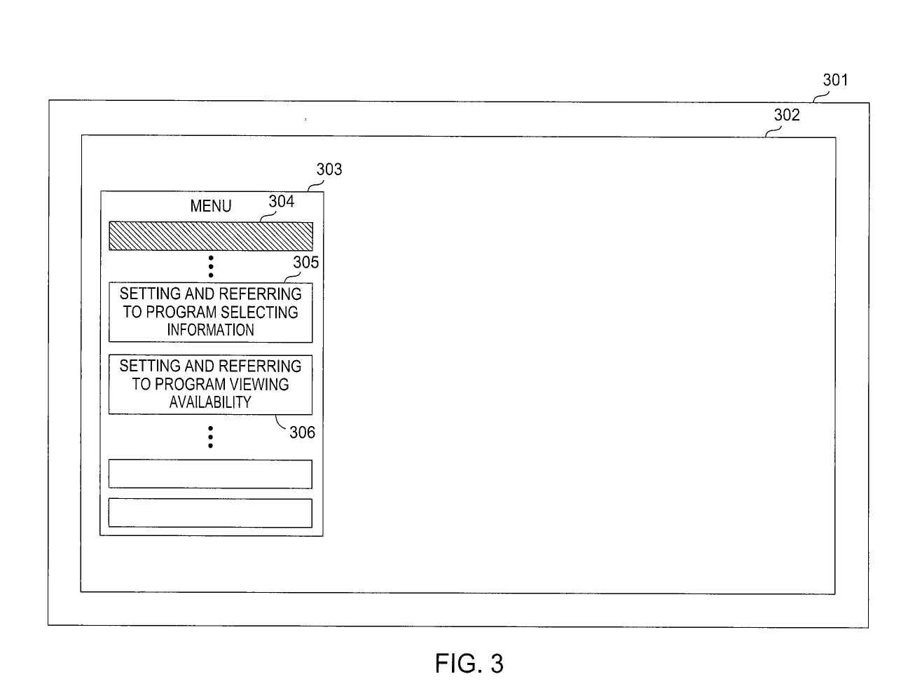

Although the television receiver 207 capable of performing such setting processing is assumed as the “specific terminal”, the specific terminal is not necessarily limited to the form of a television receiver. Although a description with reference to FIG. 3 and the following drawings will be given below on the assumption that the “specific terminal” is a television receiver, for the purpose of convenience, the form of the “specific terminal” is not necessarily a television receiver. For example, the “specific terminal” may be a personal computer 209, a tablet computer 210, or the like.

In addition, the program filtering processing according to the exemplary embodiment is not necessarily performed by the “specific terminal” 206 installed in the school. For example, the settings for the program filtering processing may be performed by an external management company that is under contract with the school. In such a case, the content set by the management company is reflected in the configuration of the television receivers of the television system 201 in the school, and thus, becomes more difficult for the students to access the program filtering process.

FIG. 2 also shows an example of such a case, and shows that it is possible to connect the management company 213 through internet connection 212 outside the school via a router 211 and set the program filtering processing by a “specific terminal” 214 installed in the management company. In this example, the “specific terminal” 206 installed in the school is used to monitor the settings of the content of the filtering processing set by the external management company 213. That is, the “specific terminal” 206 is used for the purpose of checking the setting content as requested by the external management company to change the setting content for the filtering processing. In addition, although the “specific terminal” 214 described herein is in the form of a personal computer, the form of the device is not necessarily limited thereto.

Hereinafter, a description will be given for a case where the “specific terminal” is in the form of a television receiver for the purpose of convenience.

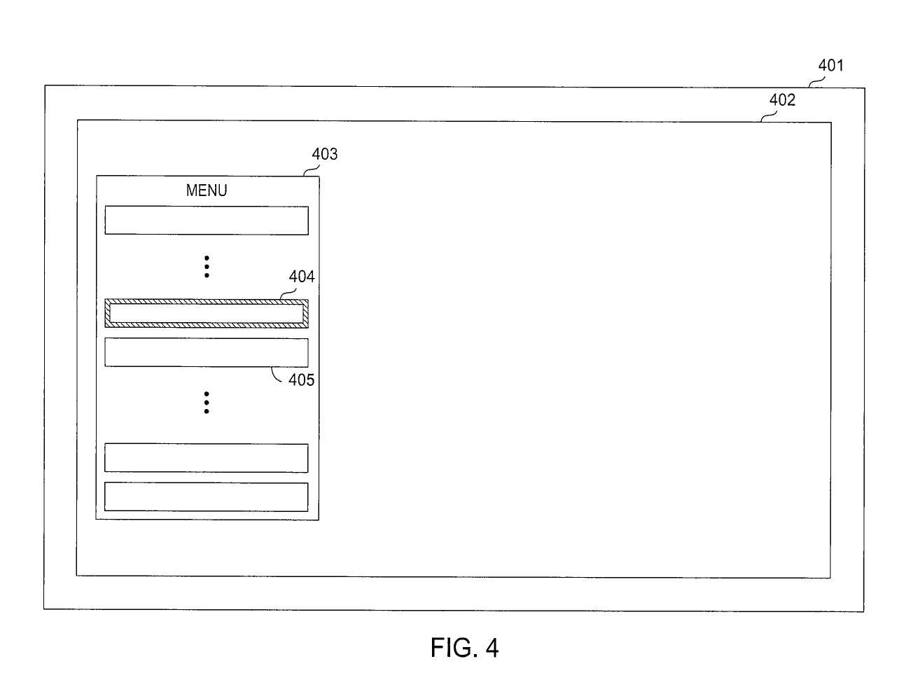

FIG. 3 is a diagram of an operation screen in the “specific terminal” 206 shown in FIG. 2, which shows a state in the uppermost stage to be branched into individual setting processing described later with reference to FIG. 4 and the following drawings.

For example, a menu screen 303 for performing various kinds of setting processing is displayed on a screen 302 of the “specific terminal” which is a television receiver 301. An item for setting the program filtering processing according to the exemplary embodiment is included among other setting items displayed on the menu screen 303. One of the items is an item “setting and referring to program selecting information” 305, and by selecting the item it is possible to proceed to processing for setting a keyword for permission or blocking or category information. Another setting item is an item “setting and referring to program viewing availability” 306, and by selecting the item it is possible to proceed to processing for setting viewing availability for each program without depending on keyword or category information. In addition, the item 305 and the item 306 may not be selected in the state shown in FIG. 3, such that an item 304 and not the items 305 and 306 may be selected.

FIGS. 4 to 14 are operation diagrams in the “specific terminal” 206 shown in FIG. 2, which show a series of screens for the processing of setting the keyword for permission or blocking or category information to select programs which can be viewed and recorded in the school.

First, FIG. 4 shows a state where an item “setting and referring to program selecting information” 404 included in a menu screen 403 is selected in order to proceed to processing for setting a keyword for permission or blocking or category information. By a user selection of the item “setting and referring to program selecting information” 404 with an operation of a remote controller of a television receiver and pressing a set button, for example, it is possible to start processing corresponding to the item.

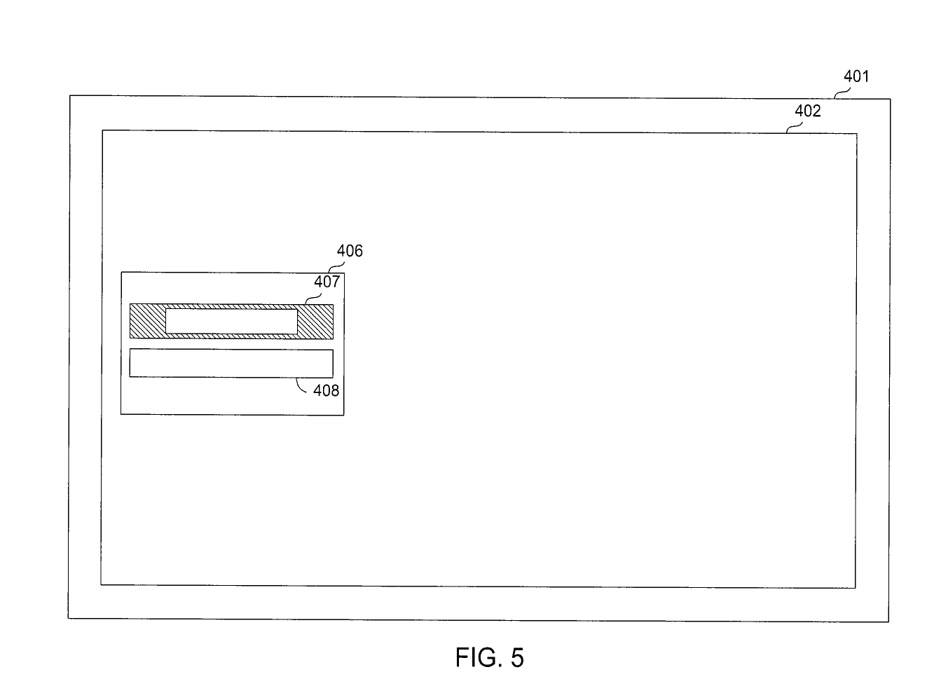

FIG. 5 shows a screen displayed after the item “setting and referring to program selecting information” 404 is selected in FIG. 4, which is a screen for selecting whether to set a keyword or set category information as selecting information. In the example shown in FIG. 5, it is assumed that an item “keywords” 407 is selected.

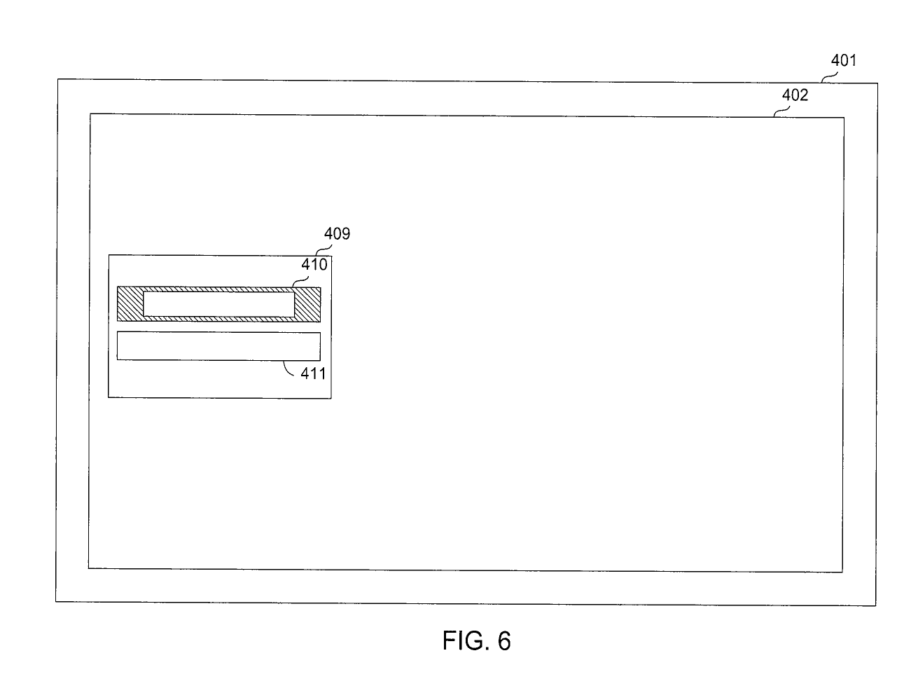

FIG. 6 shows a screen displayed after the item “keywords” 407 is selected in FIG. 5, which is a screen for selecting whether to set a keyword for permission or set a keyword for blocking. In the example shown in FIG. 6, it is assumed that an item “keywords for permission” 410 is selected.

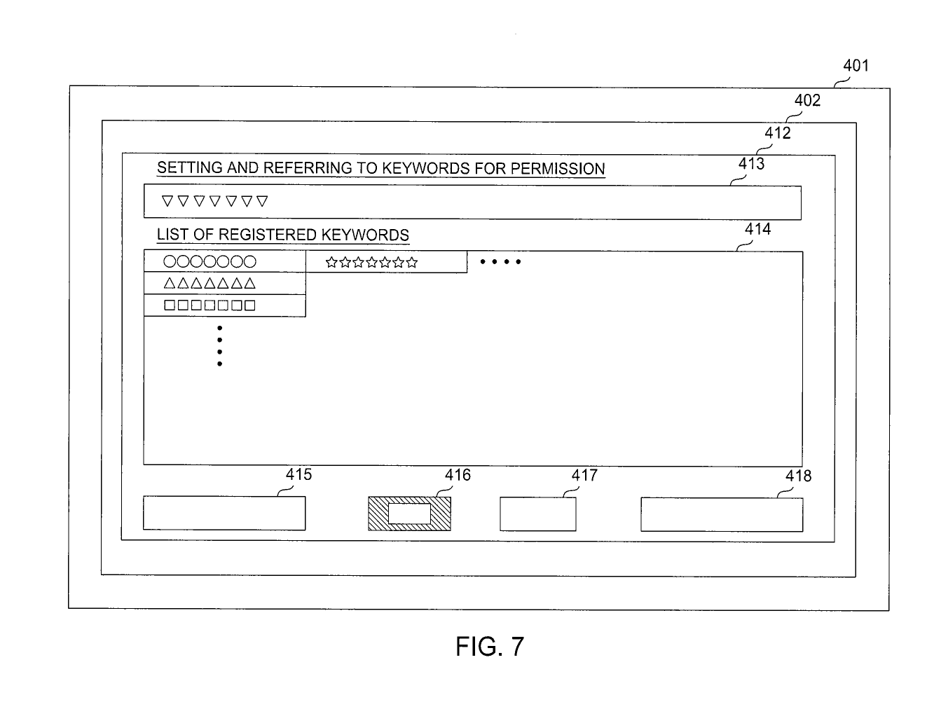

FIG. 7 shows a screen displayed after the item “keywords for permission” 410 is selected in FIG. 6, which is a screen for actually performing an operation for setting a keyword for permission or referring to registered keywords. Here, a keyword-for-permission setting and reference screen 412 is displayed, and a keyword for permission is input through an input keyword display section 413 and an appropriate input portion included in the “specific terminal” 206. The input may be made through a remote controller if the “specific terminal” is a television receiver, a keyboard if the “specific terminal” is a personal computer, and a touch panel if the “specific terminal” is a tablet computer. After the input, the input keyword is formally registered as a keyword for permission by selecting a register button 416 on the screen. A group of already registered keywords can be referred to in a registered keyword list display section 414. If too many keywords are registered so that they cannot be displayed at one time, display content in the registered keyword list display section 414 can be switched by using a previous page button 415 or a next page button 418. In addition, it is also possible to delete a registered keyword for permission by appropriately selecting the registered keyword being displayed in the registered keyword list display section 414 and selecting a delete button 417.

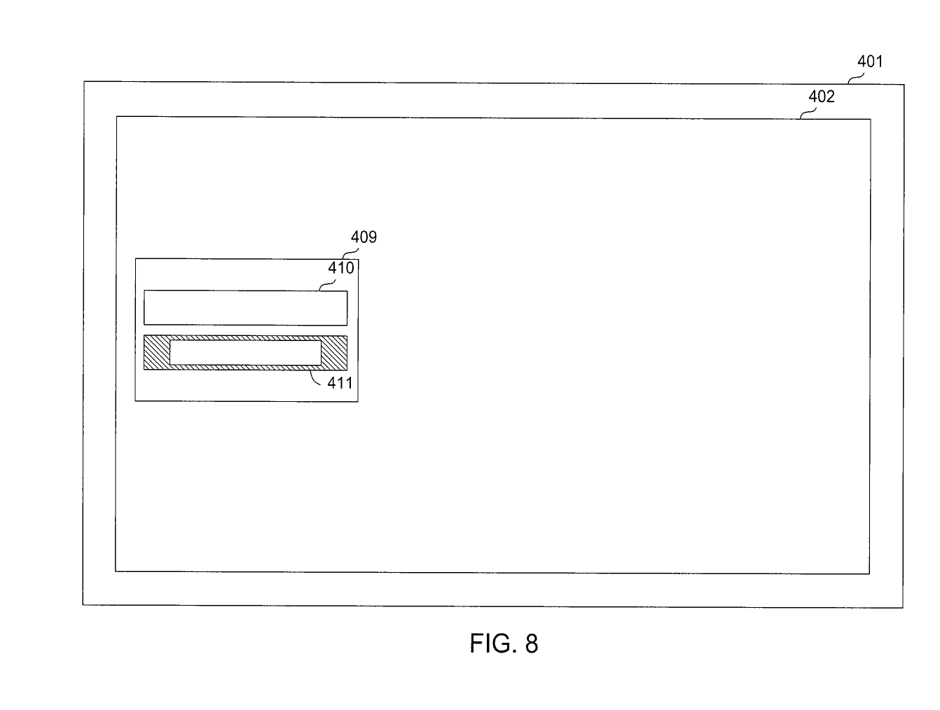

On the other hand, FIG. 8 shows a different example from that shown in FIG. 6 and shows a case where it is assumed that an item “keywords for blocking” 411 has been selected.

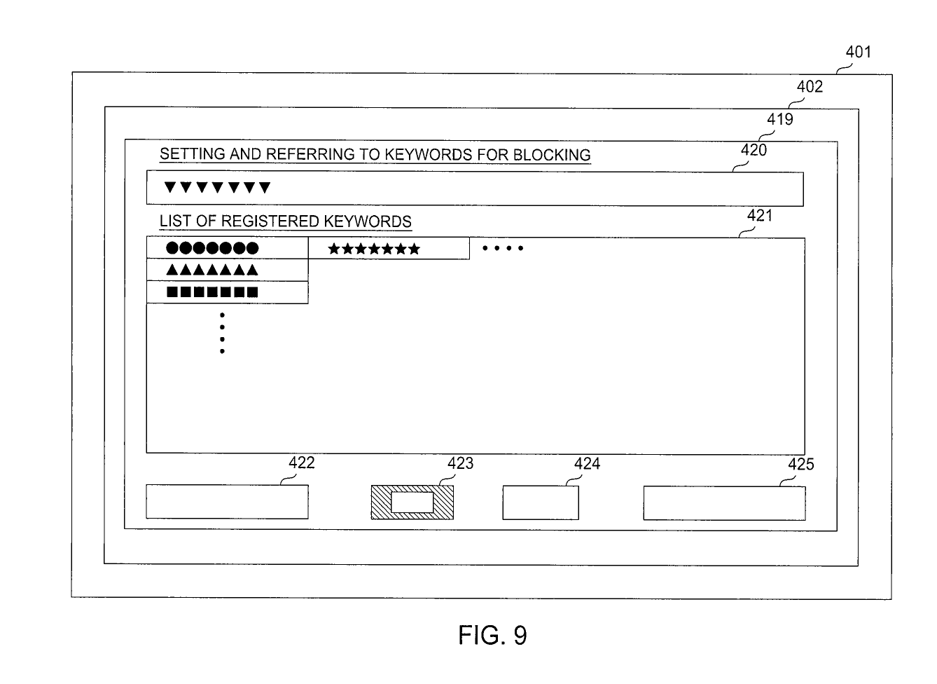

FIG. 9 is a screen displayed after the item “keywords for blocking” 411 is selected in FIG. 8, which is a screen for actually performing an operation for setting a keyword for blocking or referring to registered keywords. Here, a keyword-for-blocking setting and reference screen 419 is displayed, and a keyword for blocking is input through an input keyword display section 420 and an appropriate input portion included in the “specific terminal” 206. After the input, the input keyword is formally registered as a keyword for blocking by selecting a register button 423 on the screen. An already registered keyword group can be referred to in a registered keyword list display section 421. If too many keywords are registered so that they cannot be displayed at one time, display content in the registered keyword list display section 421 can be switched by using a previous page button 422 or a next page button 425. In addition, it is also possible to delete a registered keyword for blocking by appropriately selecting the registered keyword being displayed in the registered keyword list display section 421 and selecting a delete button 424.

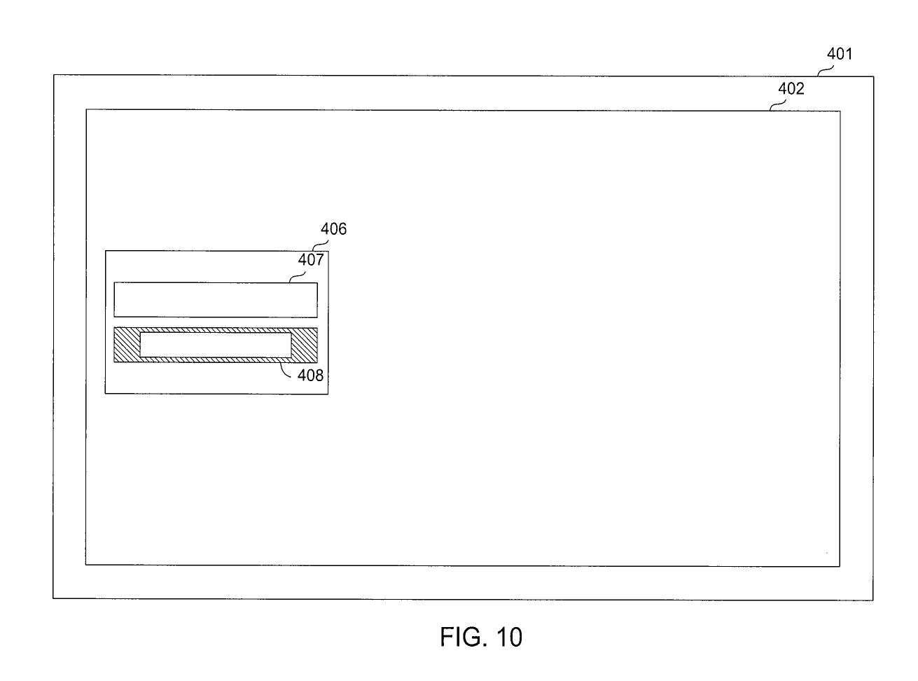

Next, FIG. 10 shows a different example from that shown in FIG. 5 and shows a case where an item “category information” 408 is selected.

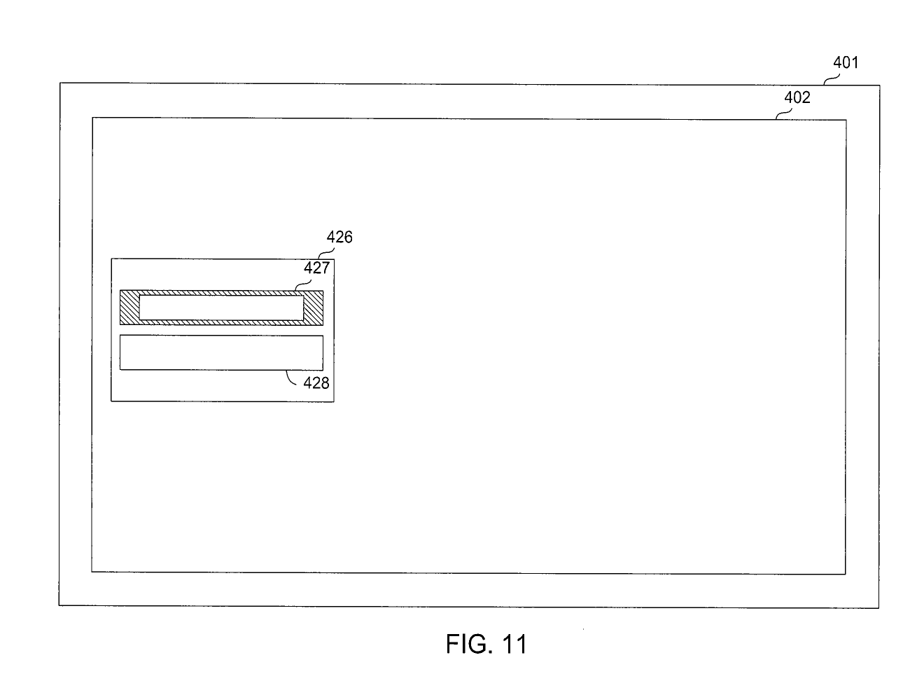

FIG. 11 shows a screen displayed after the item “category information” 408 is selected in FIG. 10, which is a screen for selecting whether to set permitted category information or set blocked category information. In the example shown in FIG. 11, it is assumed that an item “permitted category information” 427 is selected.

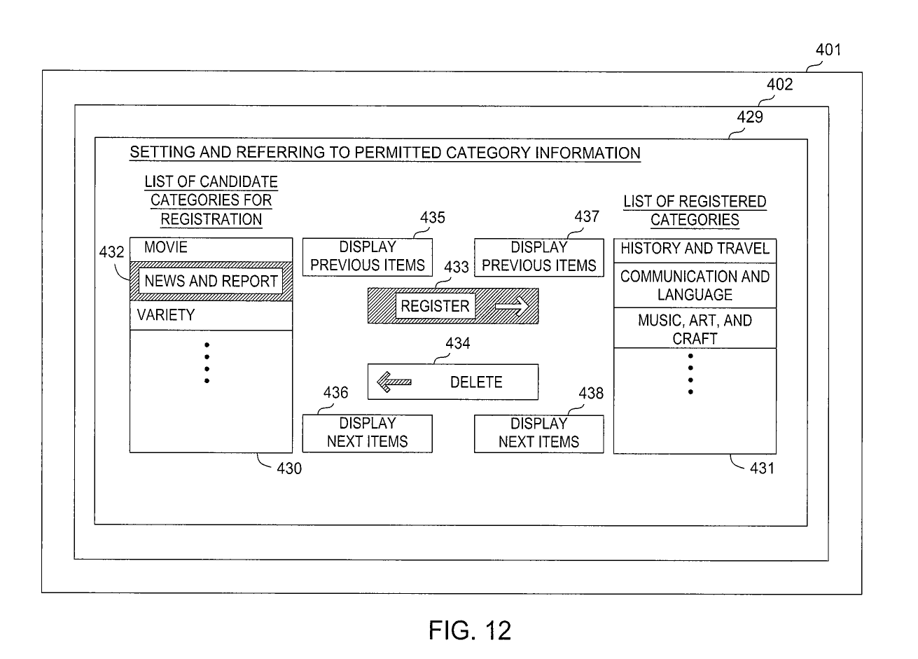

FIG. 12 shows a screen displayed after the item “permitted category information” 427 is selected in FIG. 11, which is a screen for actually performing an operation for setting permitted category information or referring to registered category information. Here, a permitted category information setting and referring screen 429 is displayed. Program category information is defined by Association of Radio Industries and Business (ARIB) standard STD-B10, for example, and program category information of corresponding programs is added to the individual programs by designating respective categories among content descriptors of program alignment information as described in the standard. In addition, although the description is given of a case of the ARIB standard, a broadcasting scheme Advanced Television Systems Committee (ATSC) in the United States or a broadcasting scheme Digital Video Broadcasting Terrestrial (DVB-T) in Europe may be employed as well as the ARIB standard.

A list of candidate category information is prepared in a registered candidate category list display section 432, and category information is formally registered as permitted category information by appropriately selecting desired category information from the list of candidate category information and then selecting a register button 433. Already registered category information can be referred to in a registered category list display section 431. In addition, it is also possible to delete registered category information by appropriately selecting registered category information being displayed in the registered category list display section 431 and selecting a delete button 434.

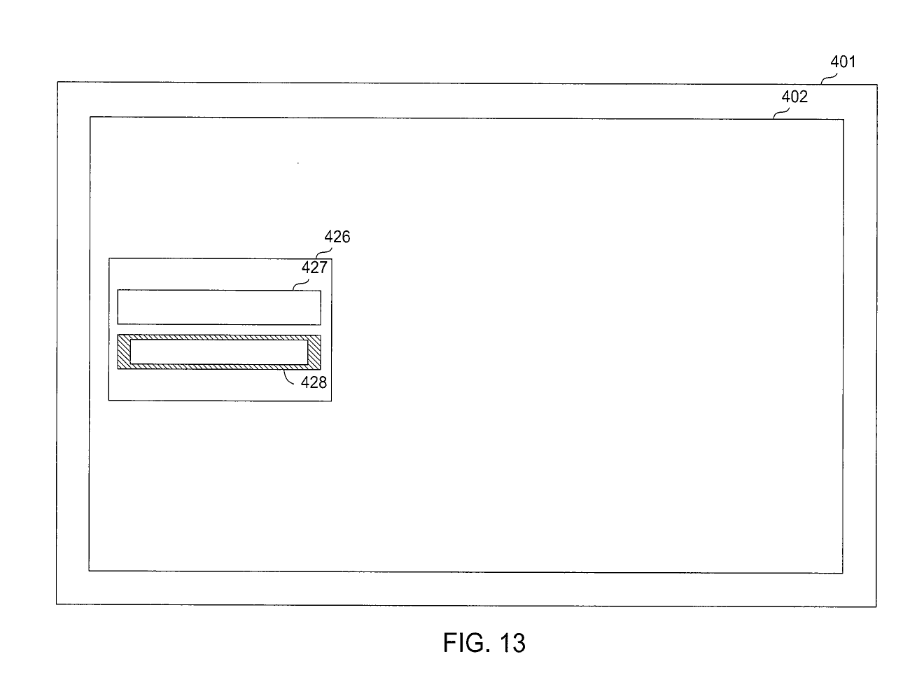

FIG. 13 shows a different example from that shown in FIG. 11 and shows a case where it is assumed that an item “blocked category information” 428 is selected.

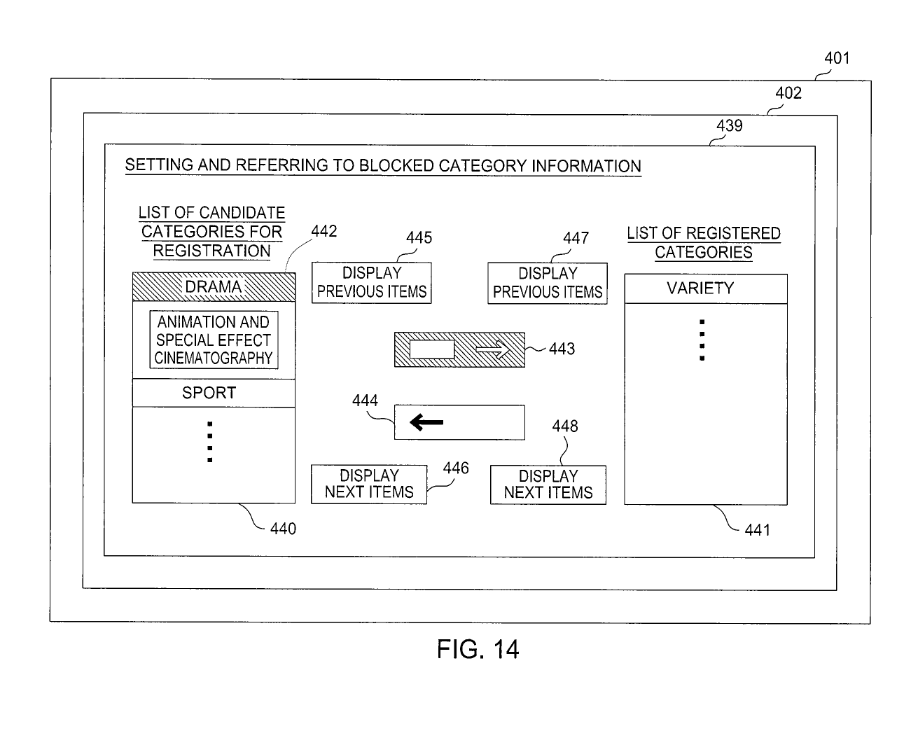

FIG. 14 shows a screen displayed after the item “blocked category information” 428 is selected in FIG. 13, which is a screen for actually performing an operation for setting blocked category information or referring to registered category information. Here, a blocked category information setting and referring screen 439 is displayed. This conforms to the permitted category information setting and referring screen 429 shown in FIG. 12, and a list of candidate category information is prepared in a registered candidate category list display section 442. In addition, category information is formally registered as blocked category information by appropriately selecting desired category information from the list of candidate category information and then selecting a register button 443. Already registered category information can be referred to in a registered category list display section 441. In addition, it is also possible to delete registered category information by appropriately selecting registered category information being displayed on the registered category list display section 441 and selecting a delete button 444.

As described above, a keyword for permission or blocking, or category information for selecting programs which can be viewed and recorded in the school is set by using the “specific terminal” 206 shown in FIG. 2 by the procedure described with reference to FIGS. 4 to 14. The setting operation can be performed by the “specific terminal” 206 shown in FIG. 2, but the television receivers other than the “specific terminal” 206, the video recorder apparatuses, and the program server apparatus in the entire school cannot perform the setting operation. In addition, if the setting for the program filtering processing is performed by the external management company 213 under contract with the school, the “specific terminal” 206 installed in the school cannot perform the setting operation described with reference to FIGS. 4 to 14. However, it is possible to check the setting content by the “specific terminal” by switching to the respective screens shown in FIGS. 4 to 14.

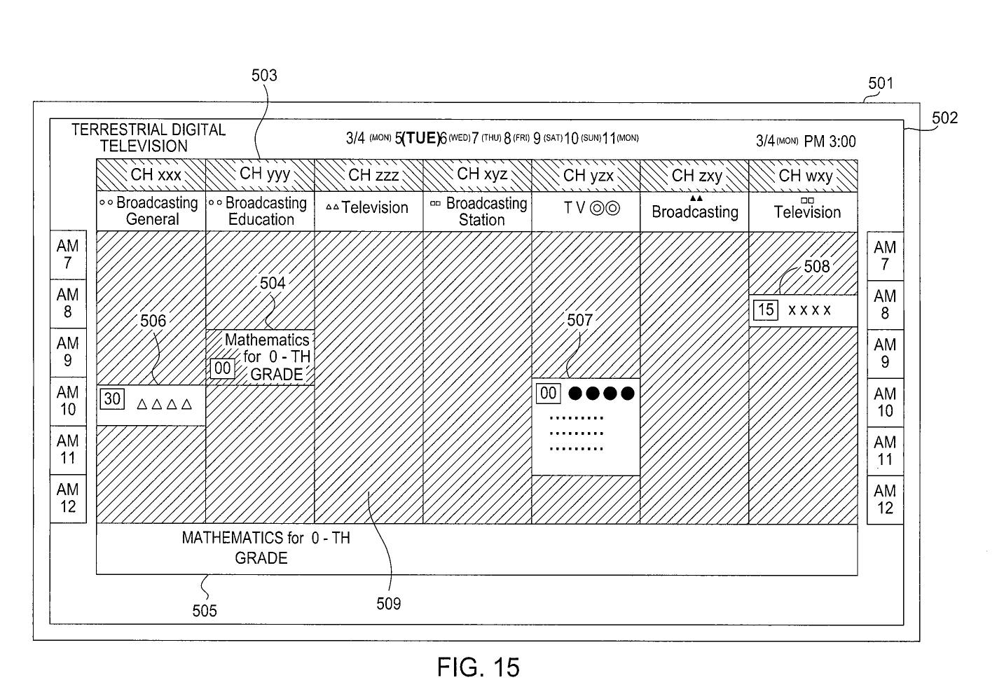

FIGS. 15 to 18 are diagrams of operations screens in the “specific terminal” 206 shown in FIG. 2, which are diagrams showing a series of screens during processing for setting permission or non-permission of individual programs in order to select programs which can be viewed and recorded in the school.

It is possible to set a keyword or category information for filtering programs which are permitted to be viewed and recorded in the school from programs which are not permitted to be viewed and recorded, by the portion described with reference to FIGS. 4 to 14 by interpreting program information. However, since program information added to each program differs depending on a broadcast station sending the program, there is also a case where a filtering effect is not sufficiently obtained based only on the keyword or the category information. In such a case, it is possible to manually set permission or non-permission of viewing and recording each program as will be described below.

First, FIG. 15 shows a state where an Electronic Program Guide (EPG) screen 503 is displayed in order to proceed to processing for setting permission or non-permission of viewing and recording each program. The screen may be switched to the EPG screen by selecting the item “setting and referring to program viewing availability” 405 included in the menu screen 403 shown in FIG. 4, or the EPG screen may be displayed by directly performing an operation for displaying the EPG screen (pressing an EPG button in the remote controller, for example). In the EPG screen 503 shown in FIG. 15, a group of programs (506, 507, and 508) which are permitted to be viewed and recorded as a result of the already set program filtering processing is displayed in a usual state. Grayed-out display 509 of programs shows a condition in which “it is possible to determine presence of programs while viewing and recording of the programs are not permitted”. Here, a program 504, which is not permitted to be viewed and recorded for some reason, but the setting of which is desired to be changed by manual setting such that viewing and recording of the program will be permitted, is being selected.

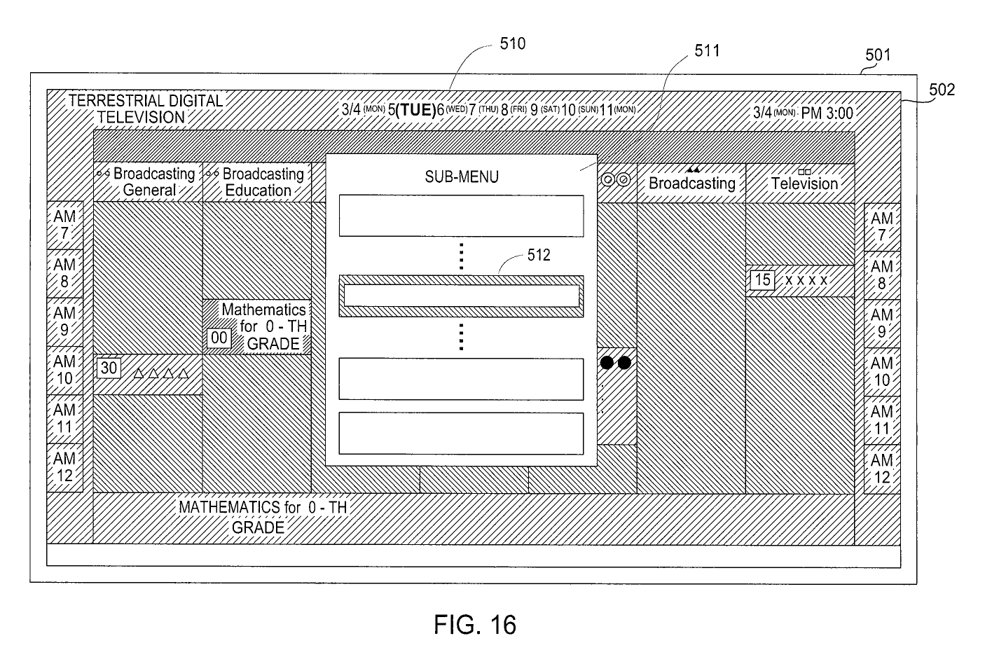

FIG. 16 shows a state where a sub-menu 511 for performing setting processing for the program 504 is being displayed. Here, an item “setting and referring to viewing and recording permission” 512 is selected in order to change the viewing and recording permission setting for the program 504.

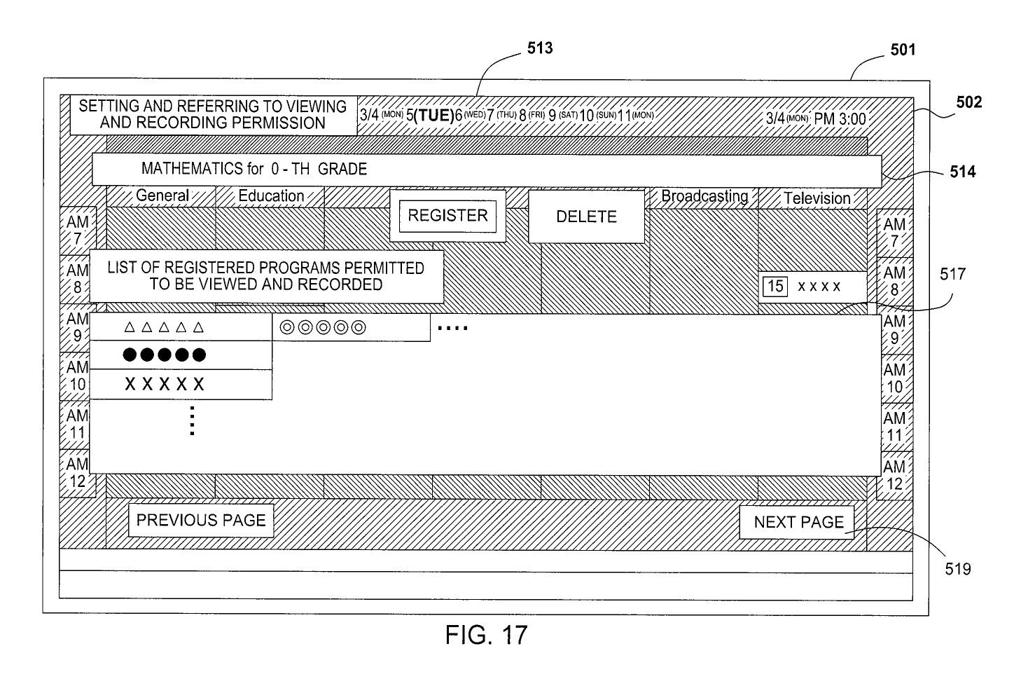

FIG. 17 is a screen displayed after the item “setting and referring to viewing and recording permission” 512 is selected in FIG. 16, which is a screen for performing an operation for setting viewing and recording permission for the program 504 or referring to a list of set programs. Here, a viewing and recording permission setting and referring screen 513 is displayed, and a program name of the target program 504, for which it is desired to manually attempt to set viewing and recording permission, is displayed in a display section 514. The program is formally registered as a target program of the viewing and recording permission by selecting a register button 515 on the screen in this state. An already registered program group can be referred to in a registered viewing and recording permission program list display section 517. If too many programs are registered so that they cannot be displayed at one time, it is possible to switch display content in the registered viewing and recording permission program list display section 517 by using a previous page button 518 and a next page button 519. In addition, it is also possible to delete the target program of the viewing and recording permission by appropriately selecting a registered keyword being displayed in the registered viewing and recording permission program list display section 517 and selecting a delete button 516.

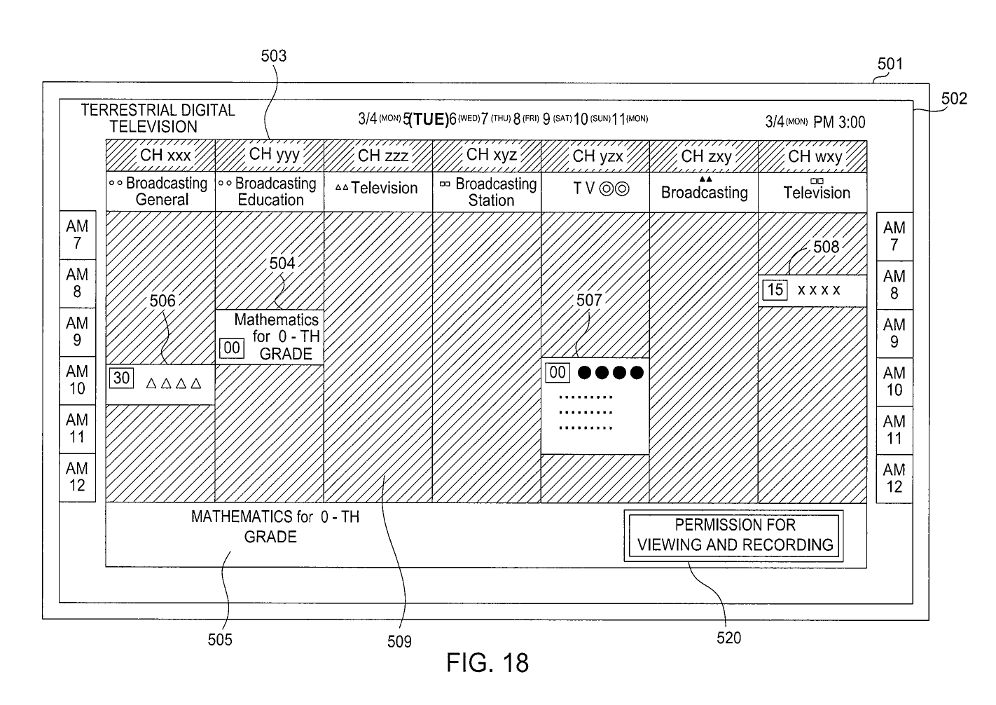

FIG. 18 shows a state where the EPG screen 503 is displayed after the setting processing in FIGS. 16 and 17 are completed. Here, the program 504, which is the target of change in the viewing and recording permission setting this time, is displayed in a usual state on the EPG screen as a formally registered target program of the viewing and recording permission by the setting processing shown in FIGS. 16 and 17. In addition, a program name display section 505 is in the lower field on the EPG screen, and in this case, a mark 520 which indicates that the program is formally registered as a target program of the viewing and recording permission is newly displayed in addition to the program name of the program.

As described above, it is possible to manually set viewing and recording permission or non-permission for each of the programs, which have not been filtered by the program filtering processing based on comparison between a keyword or category information and program information, by using the “specific terminal” 206 shown in FIG. 2 through the procedure described with reference to FIGS. 15 to 18. The setting operation can be performed by the “specific terminal” 206 shown in FIG. 2, but the television receivers other than the “specific terminal” 206, the video recorder apparatuses, and the program server apparatus in the entire school which configure the television system 201 according to the exemplary embodiment cannot perform the setting operation. In addition, if the setting for the program filtering processing is performed by the external management company 213 under contract with the school, the “specific terminal” 206 installed in the school cannot perform the setting operation described with reference to FIGS. 15 to 18. However, it is possible to check the setting content by the “specific terminal” by switching to the respective screens shown in FIGS. 15 to 18.

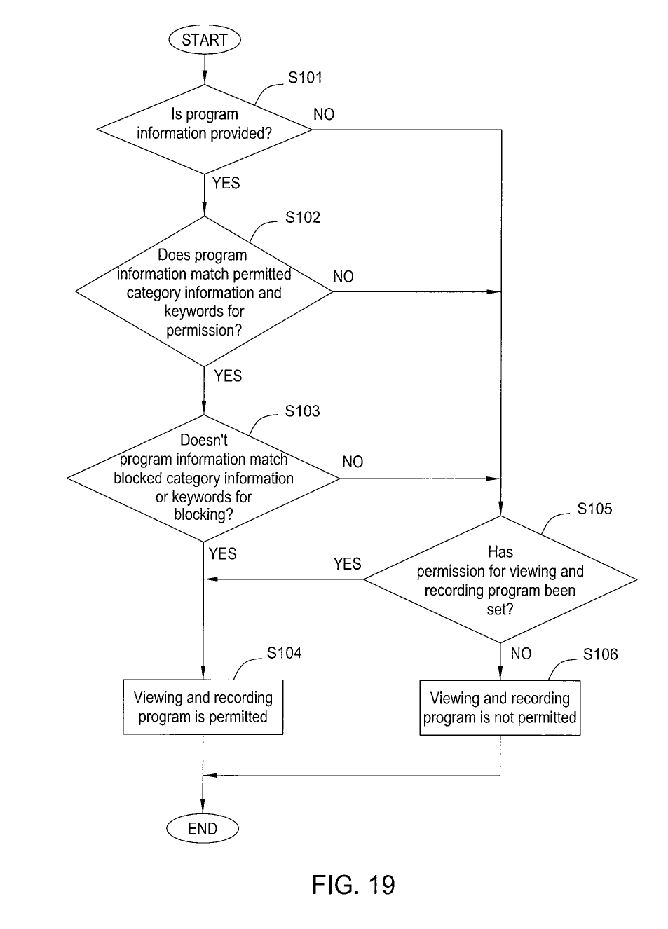

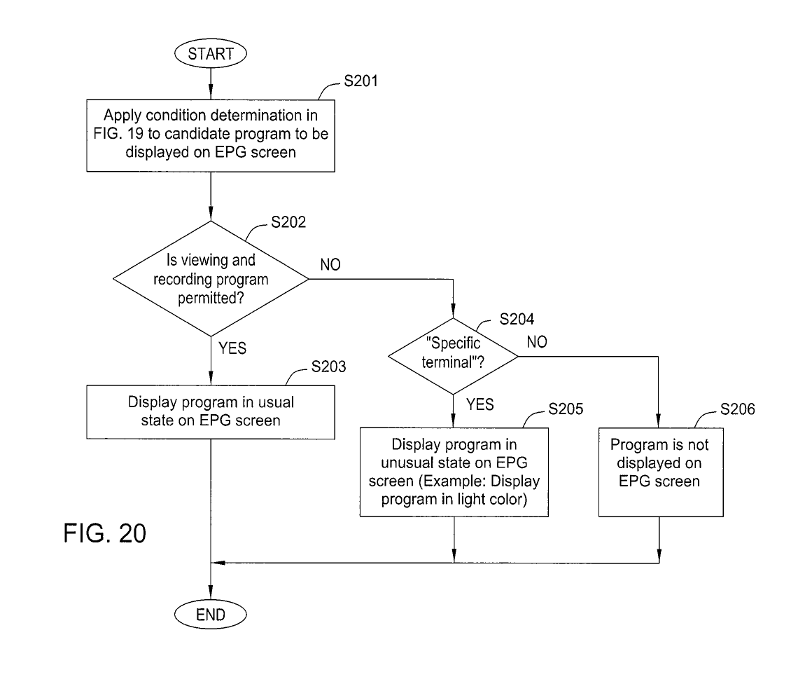

FIG. 19 is a flowchart for determining conditions for filtering programs based on the setting for viewing and recording permission set according to the methods of FIGS. 4 to 18. Here, only the main processing for determining conditions for filtering programs will be described, and processing using a result of determining the conditions will be separately described with reference to FIG. 20 and the following drawings. In addition, it is assumed that the television receiver 207 as the “specific terminal” 206, for example, performs the processing for determining conditions for filtering programs in FIGS. 19 to 22.

First, in Step S101, the control unit 118 of the television receiver 207 determines whether or not a target program has associated program information and causes the processing to branch. If program information is available, the control unit 118 moves on to the next processing Step S102. If program information is not available, the control unit 118 causes the processing to branch to Step S105 as will be described later.

In Step S102, the control unit 118 evaluates the program information of the target program, determines whether or not the program information matches the permitted category information or the keyword for permission described with reference to FIGS. 4 to 7 and FIGS. 10 and 11, and branches the processing. If the program information matches the permitted category information or the keyword for permission for the program, the control unit 118 moves on to the next step S103. If the program information does not match the permitted category information or the keyword for permission, the control unit 118 causes the processing to branch to Step S105 as will be described later.

In Step S103, the control unit 118 evaluates the program information of the target program, determines whether or not the program information matches the blocked category information or the keyword for blocking described with reference to FIGS. 8 to 10 and FIGS. 13 and 14, and causes the processing to branch. If the program information does not match the blocked category information or the keyword for blocking, the control unit 118 moves on to Step S104, determines that the program is a program permitted to be viewed and recorded, and completes a series of processing. Alternatively, if the program information matches the blocked category information or the keyword for blocking, the control unit 118 causes the processing to branch to Step S105.

In Step S105, the control unit 118 determines whether or not the programs, to which program information is available, programs which do not match the permitted category information or the keyword for permission, or the programs which are determined to match the blocked category information or the keyword for blocking are programs for which viewing and recording permission has been manually set, and causes the processing to branch. If a program is determined to be a program, for which viewing and recording permission has been manually set, the control unit 118 moves on to Step S104, determines that the program is a program permitted to be viewed and recorded, and completes a series of processing. On the other hand, if a program is determined not to be a program, for which viewing and recording permission has been manually set, the control unit 118 moves on to Step S106, determines that the program is a program not permitted to be viewed and recorded, and completes a series of processing. As described above, the control unit 118 determines whether or not a target program is a program permitted to be viewed and recorded.

FIG. 20 is a flowchart of processing for switching a program display state on the EPG screen based on a result of determining the conditions for filtering programs as described in FIG. 19.

First, in Step S201, the control unit 118 of the television receiver 207 determines conditions for filtering programs as described above with reference to FIG. 19 for programs as display candidates on the EPG screen.

In subsequent Step S202, the control unit 118 determines a result of determining conditions for filtering programs in Step S201 and causes the processing to branch. If the program is determined to be a program permitted to be viewed and recorded as a result of determining conditions for filtering programs in Step S201, the control unit 118 moves on to subsequent Step S203, displays the program in a normal state on the EPG screen, and completes a series of processing (first display state). On the other hand, if the program is determined to be a program not permitted to be viewed and recorded, the control unit 118 causes the processing to branch to Step S204.

In Step S204, the control unit 118 determines whether or not the device displaying the EPG screen is the “specific terminal” 206 (including the television receiver 207) shown in FIG. 2 and causes the processing to branch. If the device is the “specific terminal” 206 shown in FIG. 2, the control unit 118 moves on to Step S205, displays the program in an unusual state (second display state), and completes a series of processing. The unusual state means a state where a program can be clearly discriminated from a program permitted to be viewed and recorded while presence itself of the program can be recognized, and for example, the program is displayed in a light color, or the program is displayed in overlaid gray colors. On the other hand, if the device is a general television receiver or the like other than the “specific terminal” 206 (including the television receiver 207) shown in FIG. 2, the control unit 118 moves on to Step S206, determines not to display the program on the EPG screen, and completes a series of processing. As described above, programs permitted to be viewed and recorded are displayed on the EPG screen in the state with a different condition from that for programs not permitted to be viewed and recorded.

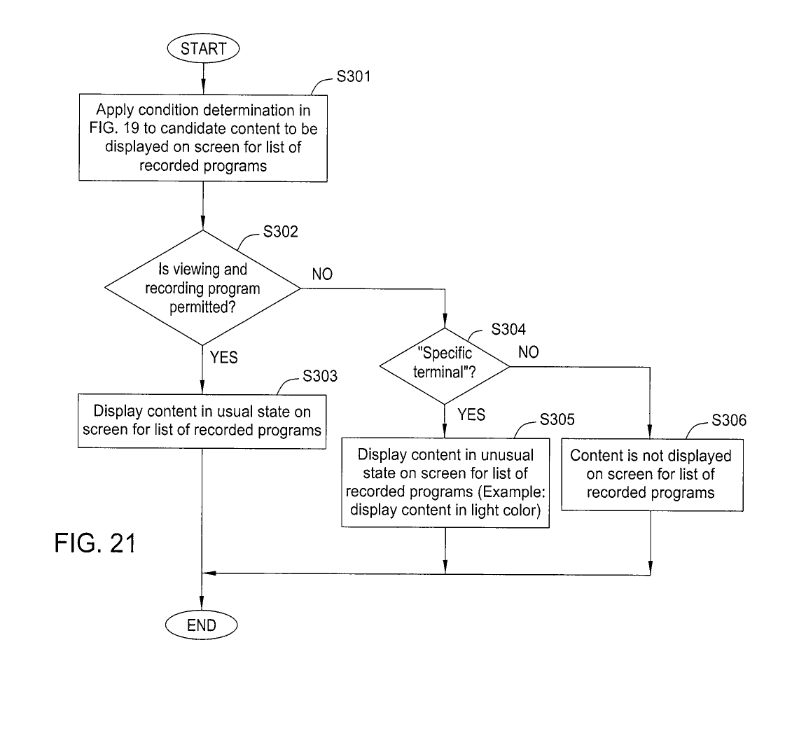

FIG. 21 is a flowchart of processing for switching a recorded content display state on a screen for a list of recorded programs based on the result of determining conditions for filtering programs as described in FIG. 19.

Content self-recorded by using the television receivers (devices with a recording function), the video recorder apparatuses, and the program server apparatus which configure the television system according to the exemplary embodiment, is also recorded after applying the conditions for filtering programs according to the exemplary embodiment. However, a case where content recorded by an external device which does not configure the television system is copied in a storage device in the television system, is excluded. That is, there is a possibility that content not permitted to be viewed is present in the storage device in the television system at the timing of the copying depending on a setting condition. This is because the conditions for setting processing described with reference to FIGS. 3 to 14 are not changed and the manual recording and viewing setting described with reference to FIG. 19 is not permitted. Processing for switching the recorded content display state on the screen for the list of recorded programs will be described below on the assumption of such a case.

First, in Step S301, the determination of conditions for filtering programs described with reference to FIG. 19 is performed on content for a list of recorded programs.

Then, in subsequent Step S302, the control unit 118 of the television receiver 207 determines a result of determining conditions for filtering programs in Step S301 and causes the processing to branch. If the content is determined to be content permitted to be viewed and recorded as a result of determining conditions for filtering programs in Step S301, the control unit 118 moves on to subsequent Step S303, displays the content in a usual state on the screen for the list of recorded programs, and completes a series of processing. On the other hand, if the content is determined to be content not permitted to be viewed and recorded, the control unit 118 causes the processing to branch to Step S304.

In Step S304, the control unit 118 determines whether the device which displays the screen for the list of recorded programs is the “specific terminal” 206 (including the television receiver 207) shown in FIG. 2 and causes the processing to branch. If the device is the “specific terminal” 206 (including the television receiver 207) shown in FIG. 2, the control unit 118 moves on to Step S305, displays the content in an unusual state, and completes a series of processing. The unusual state means a state where content can be clearly discriminated from content permitted to be viewed and recorded while presence itself of the content can be recognized, and for example, the content is displayed in a light color, or the content is displayed in overlaid gray colors. On the other hand, if the device is a general television receiver or the like other than the “specific terminal” 206 shown in FIG. 2, the control unit 118 moves on to Step S306, determines not to display the content on the screen for the list of recorded programs, and completes a series of processing. As described above, contents permitted to be viewed and recorded are displayed on the screen for the list of recorded programs in the state with a different condition from that for contents not permitted to be viewed and recorded.

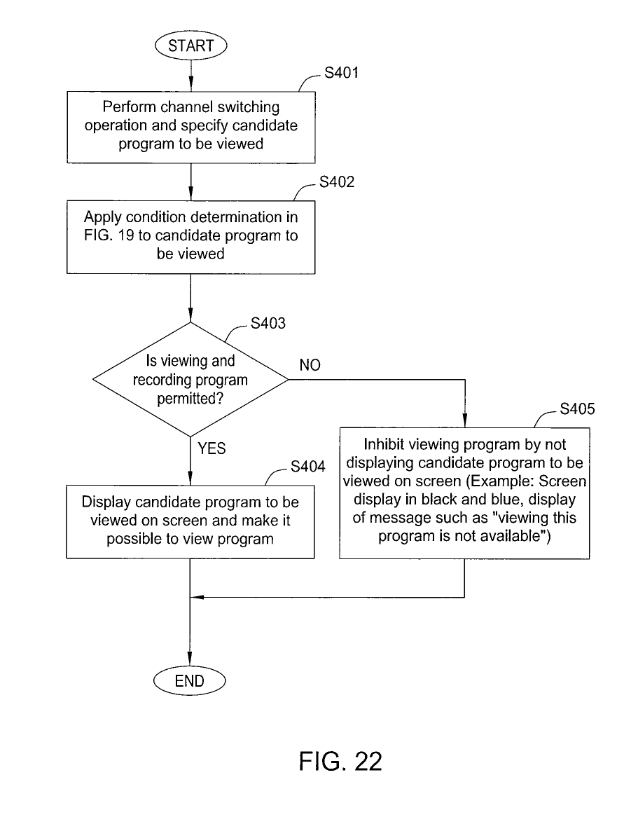

FIG. 22 is a flowchart of processing for switching an on-air program screen display state after channel switching is performed on a general television receiver or the like other than the “specific terminal” 206 shown in FIG. 2 based on the result of determining conditions for filtering programs as described in FIG. 19. In addition, it should be recognized that the general television receiver also includes a control unit (not shown) for starting software, and the control unit performs control in the following determination flow.

First, in Step S401, the control unit performs an operation for switching channels of the television receiver or the like and specifies programs as viewing candidates.

Then, in subsequent Step S402, the control unit determines conditions for filtering programs described with reference to FIG. 19 for the viewing candidate programs.

In Step S403, the control unit of the general television receiver determines a result of determining conditions for filtering programs in Step S402 and causes the processing to branch. If a program is determined to be a program permitted to be viewed and recorded as a result of determining conditions for filtering programs in Step S402, the control unit moves on to subsequent Step S404, displays the viewing candidate programs in a usual state on the screen, and completes a series of processing. On the other hand, if the program is determined to be a program not permitted to be viewed and recorded, the control unit causing the processing to branch to Step S405, determines that the viewing candidate program is not displayed on the screen and cannot be viewed, and completes a series of processing. In such a case, the screen of the television receiver may be in a state of a black screen or a blue screen, or alternatively, a message such as “viewing of this program is not available” may be displayed on the screen. As described above, content permitted to be viewed and recorded is displayed on the screen in the state with a different condition from that for content not permitted to be viewed and recorded.

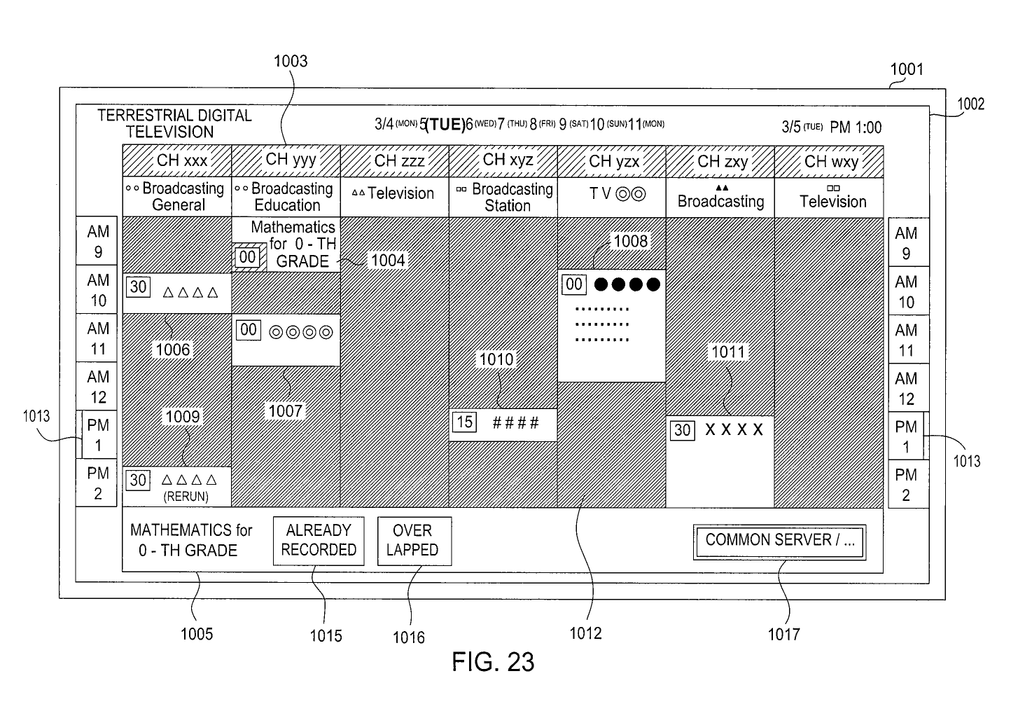

FIG. 23 is a diagram of an EPG screen in the general television receiver or the like other than the “specific terminal” 206 shown in FIG. 2.

Here, the programs not permitted to be viewed and recorded are not displayed on the EPG screen, and only programs permitted to be viewed and recorded are intentionally displayed in an irregularly missing state as described above with reference to the flowchart in FIG. 20. In addition, an EPG screen 1003 of the television receiver displays not only current and future on-air programs but also content which was already broadcasted in a past time slot and is recorded in the storage device in the television system according to the exemplary embodiment. That is, a configuration in which recorded content is displayed together by a user interface which is uniformly in the form of the EPG screen is employed. The current time slot is displayed by a mark 1013 and a mark 1014 in the EPG screen 1003, and programs 1009, 1010, and 1011 after the time slot are programs permitted to be viewed and recorded in the current and future time slots. In relation to content 1004, 1006, 1007, 1008, and the like in a time slot before the current and future time slots, recorded content is displayed in the form of the EPG screen.

The already recorded content 1004 is focused on the EPG screen 1003 shown in FIG. 23, and a content name 1005 of the content is displayed in a display section in a lower field on the EPG screen. In addition to the content name 1005, a mark 1015 which indicates that the content is not an on-air program but recorded content and a mark 1016 which indicates that the content is recorded in an overlapped manner in a plurality of storage devices in the television system are displayed. Furthermore, a storage device name 1017 and the like of a storage device where content is recorded are also displayed on the EPG screen 1003. In addition, the storage device name 1017 of the storage device where the content is recorded is partially displayed herein due to restriction of the number of the characters to be displayed on the screen.

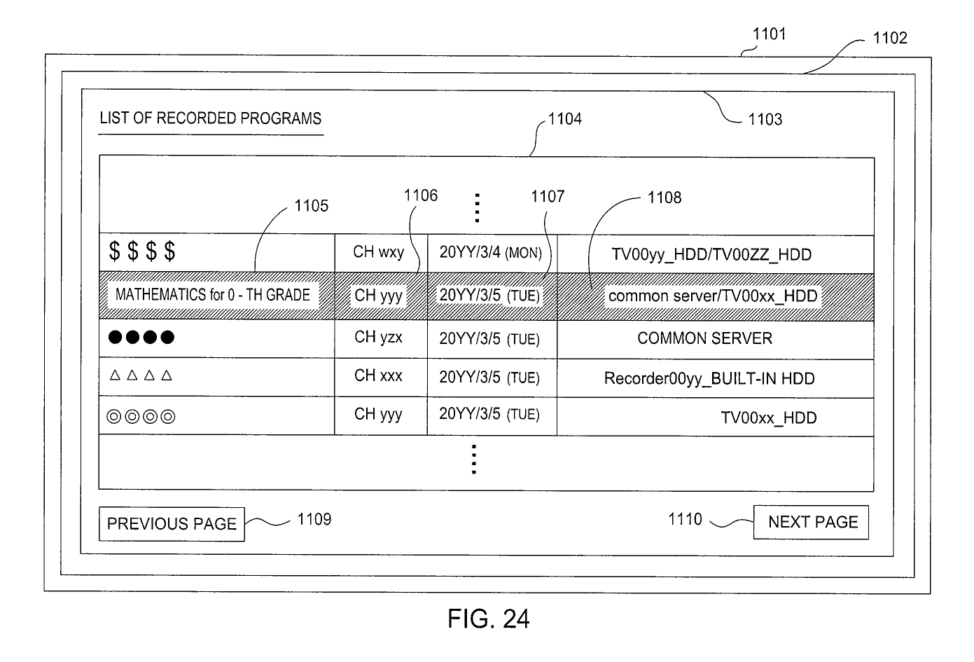

FIG. 24 is a diagram of a screen for a list of recorded programs in the general television receiver, or the like, other than the “specific terminal” 206 shown in FIG. 2. Here, only content permitted to be viewed and recorded is displayed as described above with reference to the flowchart in FIG. 21.

A recorded program list display screen 1103 is shown in FIG. 24, and a list 1104 of content recorded in the storage device in the television system according to the exemplary embodiment, which includes content displayed at a part of the past time slot on the EPG screen shown in FIG. 23, is shown. A description will be given while appropriate recorded content is selected as an example. A name 1105 of the content, a channel name 1106, with which the content was broadcasted, and a recording data 1107 are displayed. In addition, if the content is recorded in a superimposed manner in a plurality of storage devices in the television system, a set of storage device names 1108 of the storage devices where the content is recorded are also displayed.

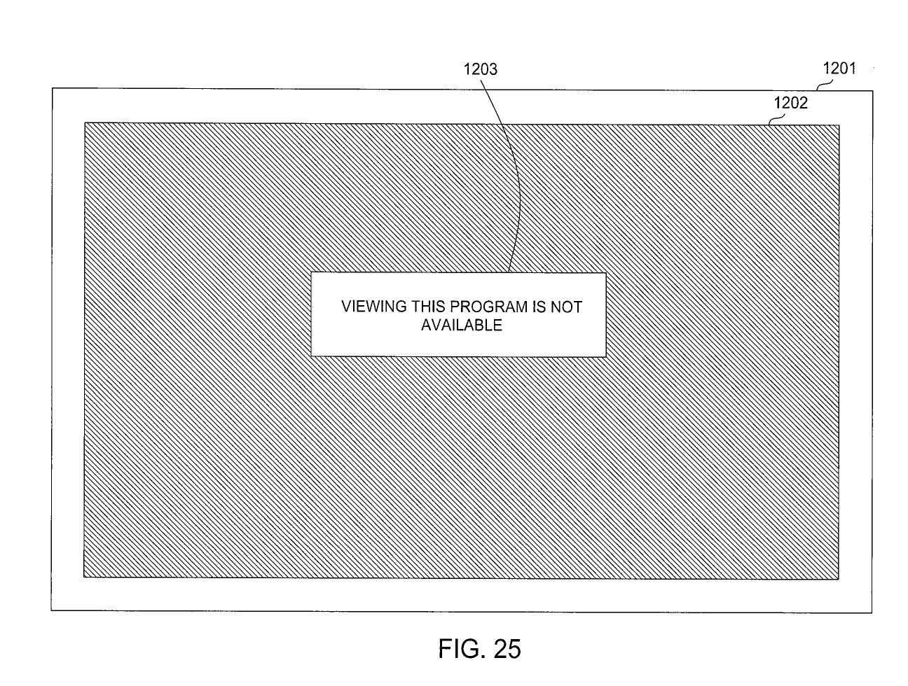

FIG. 25 is a diagram of on-air program display by the general television receiver or the like other than the “specific terminal” 206 shown in FIG. 2.

Here, a state where programs not permitted to be viewed and recorded cannot be viewed is shown as described above with reference to the flowchart shown in FIG. 22. If a program selected by switching channels is a program not permitted to be viewed and recorded in FIG. 25, a message 1203 “viewing of this program is not available” is displayed on the screen. However, the screen may be left as a blue screen or a black screen without displaying such a message as described above with reference to FIG. 22.

Although the exemplary embodiment is described above, points of the exemplary embodiment are organized as follows.

(1) The television system has a mechanism capable of setting “first keyword information or category information for permission” and “second keyword information or category information for blocking” and a mechanism for comparing the first or second keyword information or category information with program information added to a program.

(2) Only programs with program information which matches the first keyword information or category information among viewable programs which can be displayed on-air via a tuner and recorded programs which are reproduced from a storage device such as a server are regarded as display candidate programs. Programs with program information which does not match the conditions of the first keyword information and category information are not displayed on the EPG as well as the screen.

(3) Furthermore, only programs which do not match the second keyword information and category information among the display candidate programs with program information which match the first keyword information and category information are finally regarded as programs which can be displayed. Programs with program information which matches the conditions of the second keyword information and category information are not displayed on the screen even if the programs clear the condition determination based on the first keyword information and category information.

(4) Only programs which clear the condition determination based on the first and second keyword information and category information can be viewed. Only such programs are displayed on the EPG.

As an effect of the above configurations, only programs filtered by using the first and second keyword information and category information can be viewed, and other programs cannot be viewed at all in the school. In doing so, it is possible to prevent students from viewing programs which are irrelevant to course content and enhance convenience of users, namely teachers who manage classroom situations.

Furthermore, the exemplary embodiment also includes the following configurations.

(5) The television system further includes a “mechanism capable of manually setting viewing permission or non-permission” in a case where filtering processing using the first or second keyword information or category information does not sufficiently function since program information is not added or insufficient, regardless of whether the program is to be displayed on-air or reproduced from a storage device. Such a program can be viewed in the classrooms if permission of the program is manually set.

Programs accumulated in a storage device are provided with “permission flags” as unique information. In the case of on-air viewing, it is considered that “a program name”, “a broadcast station”, “a broadcast time slot”, and the like are used as information for determining permission or non-permission.

One advantage of the above configurations is that it is possible to achieve the same effect by the manual setting operation even if it is not possible to sufficiently make a determination based only on the first and second keyword information or category information from (1) to (4) due to a difference in the grading of the program information added to programs depending on broadcast stations.

(6) The operation for setting the first and second keyword information and category information and the operation for manually setting viewing permission or non-permission cannot be performed by all the television receivers which configure the audio-visual system. Such operations can be performed only by the “specific terminal”, and the content can be applied to all the other television receivers which are connected to a network and configure the audio-visual system. In addition, the “specific terminal” may be a “television installed in a teachers' staff room”, for example, or may be a personal computer or a tablet terminal instead of the television receiver. Furthermore, the “specific terminal” may not be installed in the school and may be installed in and operated by a management company outside the school, which made a contract with the school where the audio-visual system is installed.

As an effect of the above configurations, it is possible to reduce risk of the setting being changed by students who have recently become adept at operating IT devices and to enhance convenience of users, namely teachers who manage the classroom situations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display apparatus which receives digital broadcasts transmitting multiplexed program information for each program, the apparatus comprising:
a first setting unit configured to set first criteria relating to a keyword or a category for permitting viewing of the program;
a second setting unit configured to set second criteria relating to a keyword or a category for blocking viewing of the program; and
a control unit configured to compare the first criteria set by the first setting unit with the multiplexed program information, compare the second criteria set by the second setting unit with the multiplexed program information if the program has multiplexed program information which matches the first criteria, and permit viewing of the program if the program has multiplexed program information which does not match the second criteria.

2. The apparatus according to claim 1,
wherein the control unit is configured to allow manual entry of permitted program information for permitted programs, compare the first criteria set by the first setting unit with the multiplexed program information, further compare the manually entered permitted program information with the multiplexed information if the program has multiplexed program information which does not match the first criteria, and permits viewing of the program if the multiplexed program information matches the manually entered permitted program information.

3. The apparatus according to claim 1,
wherein the control unit is configured to allow manual entry of permitted program information for permitted programs, compare the second criteria set by the second setting unit with the multiplexed program information, further compare the manually entered permitted program information with the multiplexed program information if the program has multiplexed program information which matches the second criteria, and permit viewing of the program if the multiplexed program information matches the manually entered permitted program information.

4. The apparatus according to claim 2,
wherein the video display apparatus has a recording function for recording the program, and
wherein the control unit is configured to allow manual entry of permitted program information for permitted programs, compare the first criteria set by the first setting unit with the multiplexed program information, further compare the manually entered permitted program information with the multiplexed program information if the multiplexed program information has program information which does not match the first criteria, and permit recording of the program if the multiplexed program information matches the manually entered permitted program information.

5. The apparatus according to claim 3,
wherein the video display apparatus has a recording function for recording the program, and
wherein the control unit is configured to allow manual entry of permitted program information for permitted programs to permit recording of the program, compare the second criteria set by the second setting unit with the multiplexed program information, further compare the manually entered permitted program information with the program if the multiplexed program information has program information which matches the second criteria, and permits recording of the program if the program matches the manually entered permitted program information.

6. The apparatus according to claim 1,
wherein the control unit is configured to display program information of the program in a first display state in an electronic program guide when the control unit has determined to permit viewing or recording of the program.

7. The apparatus according to claim 6,
wherein the control unit is configured to display program information of the program in a second display state different from the first display state in the electronic program guide when the control unit has determined to block viewing or recording of the program.

8. The apparatus according to claim 7,
wherein the first and second setting units are remotely located with respect to the control unit.

9. The apparatus according to claim 8,
wherein the control unit is at a location for viewing or recording of the program.

10. The apparatus according to claim 1,
wherein the control unit is configured to compare a program recorded by a recording unit recording the program with the first criteria, compare the second criteria with the multiplexed program information of the program if the program has multiplexed program information which matches the first criteria, permit viewing of the program if the program has multiplexed program information which does not match the second criteria, and controls to display the program permitted to be viewed in a first display state on a screen.

11. The apparatus according to claim 10,
wherein the control unit is configured to display program information of the program in a second display state different from the first display state on the screen when the control unit has determined to block viewing or recording of the program.

12. The apparatus according to claim 11,
wherein the first and second setting units are remotely located with respect to the control unit.

13. The apparatus according to claim 12,
wherein the control unit is at a location for viewing or recording of the program.

14. A television system provided with a plurality of video display apparatuses which receive digital broadcasts transmitting multiplexed program information corresponding to each program, the video display apparatuses being connected to a network, the system comprising:
a specific video display apparatus is configured to permit or block viewing or recording of the program among the plurality of video display apparatuses,
wherein the specific video display apparatus comprises;
a first setting unit configured to set first criteria relating to a keyword or a category for permitting viewing of the program;
a second setting unit configured to set second criteria relating to a keyword or a category for blocking viewing of the program; and
a control unit configured to compare the first criteria set by the first setting unit with the program information, compare the second criteria set by the second setting unit with the program information if the program has program information which matches the first information, and permit viewing of the program if the program has program information which does not match the second criteria, and
wherein the control unit is configured to permit the program to be viewed on video display apparatuses other than the specific video display apparatus.

15. The system according to claim 14,
wherein the control unit permits recording of the program by the specific video display apparatus.

16. A method for controlling the display of a program that can be displayed over a video display apparatus which receives digital broadcasts transmitting multiplexed program information for each program, the method comprising:
setting a first criteria relating to a keyword or a category for permitting viewing of the program;
setting a second criteria relating to a keyword or a category for blocking viewing of the program;
comparing the first criteria with the program information of the program, and the second criteria with the program information if the program has program information which matches the first criteria; and
permitting viewing of the program if the program does not have program information which matches the second criteria.

17. The method of claim 16, further comprising:
manually setting permission criteria to permit viewing of the program that would otherwise not be permitting for viewing.
